(19) United States
(12) Patent Application Publication
(10) Pub. No.: US 2026/0081949 A1
(43) Pub. Date: Mar. 19, 2026

(54) METHOD AND DEVICE FOR DETECTING AND ANALYZING ABNORMALITY IN A VEHICLE

(71) Applicants: HYUNDAI MOTOR COMPANY, Seoul (KR); KIA CORPORATION, Seoul (KR)

(72) Inventor: Ha Young Lee, Hwaseong-si (KR)

(73) Assignees: HYUNDAI MOTOR COMPANY, Seoul (KR); KIA CORPORATION, Seoul (KR)

(21) Appl. No.: 19/233,979

(22) Filed: Jun. 10, 2025

(30) Foreign Application Priority Data
Sep. 13, 2024 (KR) 10-2024-0125690

(51) Int. Cl. H04L 9/40

(52) U.S. Cl. CPC H04L 63/1441; H04L 63/1425

(57) ABSTRACT

A method of detecting and analyzing a vehicle abnormality by a vehicle security operation center includes collecting logs from a vehicle and sorting the collected logs by each type. The method also includes determining whether a frequency of the logs sorted by each type is a threshold value or more and performing a specific analysis on logs determined that a frequency is greater than or equal to the threshold value. The method additionally includes responding to control the vehicle to perform one or more operations based on a result of the specific analysis.

### CROSS-REFERENCE TO RELATED APPLICATION

This application claims the benefit of and priority to Korean Patent Application No. 10-2024-0125690, filed on Sep. 13, 2024, the entire contents of which are hereby incorporated herein by reference.

### BACKGROUND

### 1. Technical Field

The present disclosure relates to a method and device for detecting and analyzing an abnormality in a vehicle.

### 2. Discussion of Related Art

Vehicles are becoming smarter and have become an important part of our daily lives. Main functions of these vehicles are connected to the Internet and smartphones and are driven by complex software. Functions, such as infotainment, automated driving functions, and improved connectivity, are all provided by software. A vehicle whose functions are provided by software is also called a software-defined vehicle. An advantage of the software-defined vehicle is that software can be updated through an over-the-air (OTA) update even after the vehicle is produced. Therefore, driving functions and interfaces can be continuously optimized over the entire lifetime cycle of the vehicle.

However, there is a disadvantage that the proportion of in-vehicle software is increasing and the connection to the Internet can make the vehicle vulnerable to cyberattacks.

The statements in this Background section merely provide background information related to the present disclosure and may not constitute prior art.

### SUMMARY

Embodiments of the present disclosure provide a method of collecting a log from a vehicle at the outside of the vehicle and detecting and analyzing an abnormality that occurs in the vehicle, and a device for performing the same.

In addition, embodiments of the present disclosure provide a method of sorting logs, which require specific analysis, among logs collected from a vehicle and detecting and analyzing an abnormality that occurs in the vehicle, and a device for performing the same. In other words, the method and device may classify logs collected from a vehicle to identify logs requiring detailed analysis, and detect and analyze abnormalities occurring in the vehicle based on the identified logs.

In addition, embodiments of the present disclosure provide a method of analyzing logs collected from a vehicle and detecting and analyzing an abnormality that occurs in the vehicle that can respond, and a device for performing the same.

According to an embodiment of the present disclosure, a method of detecting and analyzing vehicle abnormality by a vehicle security operation center is provided. The method includes collecting logs from a vehicle. The method also includes sorting the collected logs by each type. The method further includes determining whether a frequency of the logs sorted by each type is a threshold value or more. The method additionally includes performing a specific analysis on logs determined that a frequency is greater than or equal to the threshold value. The method also includes responding to control the vehicle to perform one or more operations based on a result of the specific analysis.

The types for sorting the collected logs are include at least some of a type of the vehicle, a country in which the vehicle is located, and an electronic control unit included in the vehicle.

Performing the specific analysis may include determining whether the logs, determined to have the frequency equal to or greater than the threshold value, are related to an intrusion detection system (IDS) of a vehicle or related to an electronic control unit included in the vehicle.

Responding may include, based on determining, as the result of the specific analysis, that the logs determined to have the frequency equal to or greater than the threshold value are related to the IDS of the vehicle, updating an IDS ruleset of the vehicle.

Responding may include, based on determining, as the result of the specific analysis, that the logs determined to have the frequency equal to or greater than the threshold value are related to the electronic control unit, executing a response to the electronic control unit included in the vehicle.

The method may further include re-collecting logs from the one or more vehicles based on determining that none of the frequencies are equal to or greater than the threshold value.

The threshold value may be determined based on one or more of the types of the logs.

The frequency of the logs may be determined according to one or both of a number of times the logs are generated in a set period of time or a size of the logs.

According to another embodiment of the present disclosure, a vehicle security operation center for detecting and analyzing vehicle abnormality is provided. The vehicle security operation center includes a memory, a communication module, and a processor. The processor is configured to collect logs from one or more vehicles. The processor is also configured to sort the collected logs by each type, identify whether a frequency of the logs a threshold value or more. The processor is additionally configured to perform a specific analysis on the logs identified that the frequency is greater than or equal to the threshold value. The processor is also configured to respond to control at least one vehicle, among the one or more vehicles, to perform one or more operations based on a result of the specific analysis.

The types of logs are at least some of a type of a vehicle, a country in which the vehicle is located, or an electronic control unit included in the vehicle.

The processor may be configured to determine whether the logs determined to have the frequency equal to or greater than the threshold value are related to an IDS of a vehicle or are related to an electronic control unit included in the vehicle.

The processor may be configured to update an IDS ruleset of the vehicle based on determining, as the result of the specific analysis, that the logs determined to have the frequency equal to or greater than the threshold value are related to the IDS of the vehicle.

The processor may be configured to respond in relation to the electronic control unit included in the vehicle based on determining, as the result of the specific analysis, that the logs determined to have the frequency equal to or greater than the threshold value are related to the electronic control unit included in the vehicle.

The processor may be configured to re-collect logs from the one or more vehicles based on determining that none of the frequencies are equal to or greater than the threshold value.

The threshold value may be determined based on one or more of the log types.

The frequency of the log may be determined according to one or both of a number of times the logs are generated in a set period of time or a size of the logs.

### BRIEF DESCRIPTION OF THE DRAWINGS

The above and other objects, features, and advantages of the present disclosure should become more apparent to those of ordinary skill in the art from the following detailed description taken in conjunction with the accompanying drawings, in which:

FIG. 1 is the overall system diagram for detecting and analyzing an abnormality that occurs in a vehicle, according to an embodiment of the present disclosure;

FIG. 2 is a flowchart illustrating operations of a vehicle security operation center that detects and analyzes an abnormality, according to an embodiment of the present disclosure;

FIG. 3 is a flowchart illustrating operations of the vehicle security operation center that sorts logs collected from the vehicle and determines whether specific analysis is required, according to an embodiment of the present disclosure; and

FIG. 4 is a block diagram of the vehicle security operation center, according to an embodiment of the present disclosure.

### DETAILED DESCRIPTION

Hereinafter, embodiments of the present disclosure are described in detail with reference to the accompanying drawings.

However, the technical spirit of the present disclosure is not limited to the described embodiments. Rather, the present disclosure may be implemented in various different forms, and one or more of the components among the described embodiments may be used by being selectively coupled or substituted without departing from the scope and the technical spirit of the present disclosure.

In addition, terms (including technical and scientific terms) used in embodiments of the present disclosure may be construed as meaning that may be generally understood by those having ordinary skill in the art to which the present disclosure pertains unless explicitly specifically defined and described herein. The meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, or C,” one or more among all possible combinations of A, B, or C may be included.

In addition, terms such as first, second, A, B, (a), and (b) may be used to describe components of the embodiments of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, this may include a case in which the first component is directly connected, coupled, or joined to the second component, but also a case in which the first component is “connected,” “coupled,” or “joined” to the second component by one or more other components present between the first component and the second component.

In addition, when a certain component is described as being formed or disposed “on (above)” or “below (under)” another component, the terms “on (above)” or “below (under)” may include not only a case in which two components are in direct contact with each other, but also a case in which one or more other components are formed or disposed between the two components. In addition, when described as “on (above) or below (under),” this may include the meaning of not only an upward direction but also a downward direction based on one component.

When a controller, module, component, device, element, or the like of the present disclosure is described as having a purpose or performing an operation, function, or the like, the controller, module, component, device, element, or the like should be considered herein as being “configured to” meet that purpose or to perform that operation or function.

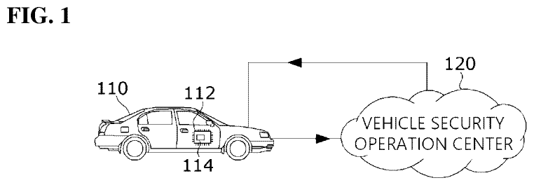

FIG. 1 is a diagram of a system for detecting and analyzing an abnormality that occurs in a vehicle according to an embodiment of the present disclosure.

Referring to FIG. 1, a system 100 for detecting and analyzing an abnormality that occurs in a vehicle includes a vehicle 110 and a vehicle security operation center (VSOC) 120. The vehicle 110 and the vehicle security operation center 120 may be connected through wireless communication. For example, the vehicle 110 and the vehicle security operation center 120 may be connected through a 5G network.

The vehicle 110 may include a central communication unit (CCU) 112 for connection with other devices in a wired or wireless manner. The CCU 112 may be an integrated wired/wireless communication controller for linking devices inside and outside the vehicle and transmitting and receiving data therebetween. The CCU 112 may function to provide advanced driving experiences such as wireless software updates, connected car services, vehicle data collection, remote diagnosis, etc.

According to one embodiment, the CCU 112 may include an intrusion detection system (IDS) 114. The IDS 114 may test and monitor traffic on a network and identify intrusion on the network. When the IDS 114 detects an abnormality on an in-vehicle network and generates a log, the CCU 112 may transmit the generated log to an external device. According to one embodiment, the IDS 114 may be formed separately and disposed outside the CCU 112 and may transmit and receive necessary data to and from the CCU 112.

The vehicle security operation center 120 may be a remote management server and may be wirelessly connected to the vehicle to detect and analyze a current security state and an operation status of the vehicle. The vehicle security operation center 120 may receive a log from the vehicle and may monitor or analyze the current security state and operation status of the vehicle based on the log. The vehicle security operation center 120 may also update the security policy of the vehicle as needed and maintain security actions in the vehicle in the latest state. Since the vehicle security operation center 120 may collect data from the vehicle in real time, the vehicle security operation center 120 may quickly detect new types of threats and quickly respond thereto. The vehicle security operation center 120 may establish various security policies in consideration of manufacturers of the vehicle, the type of the vehicle, and specifications of the vehicle, and may support the vehicle with various security policies.

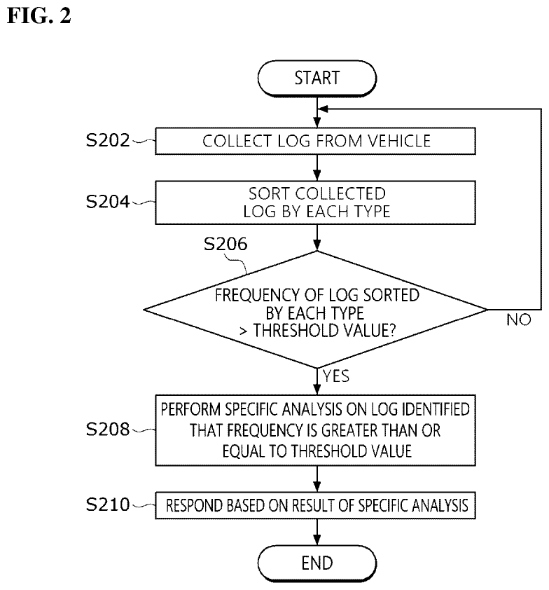

FIG. 2 is a flowchart illustrating operations of a vehicle security operation center that detects and analyzes an abnormality, according to an embodiment of the present disclosure.

Referring to FIG. 2, in an operation S202, the vehicle security operation center may collect logs from one or more vehicles. The vehicle security operation center may collect the log from a vehicle to monitor the log of the vehicle. The vehicle may include an IDS and may generate a log related to intrusion that occurs in the vehicle. The IDS may generate a log at a time point when the intrusion is detected or some time before the time point. The IDS may store the generated log in a memory. In addition, the IDS may transmit the generated log to a CCU inside the vehicle through an in-vehicle network. When receiving the log, the CCU may transmit the log to the vehicle security operation center outside the vehicle through wireless communication. According to one embodiment, when the IDS is included in the CCU and stores the generated log in a buffer, the CCU may transmit the log stored in the buffer to the vehicle security operation center outside the vehicle. According to one embodiment, the vehicle may transmit the log at a regular cycle or transmit the log immediately after the log is generated. Alternatively, the vehicle may transmit the log when the vehicle security operation center requests.

In an operation S204, the vehicle security operation center may sort collected logs by each of one or more log types. The vehicle security operation center may sort the collected logs by each of the one or more log types to efficiently analyze a large amount of logs. The vehicle security operation center may subdivide sorting criteria and may sort the collected logs. According to one embodiment, the vehicle security operation center may first sort the collected logs using an IDS algorithm or an attack detection algorithm.

The vehicle security operation center may select at least some of the type of the vehicle, a country in which the vehicle is located, and electronic control units included in the vehicle as the log types for sorting the collected log. The vehicle security operation center may identify the type of the vehicle through a vehicle identification number (VIN). A first digit of the VIN is assigned a number that is assigned differently depending on manufacturers and the types of vehicles. The vehicle security operation center may identify a country in which a collected log has been generated through a session. Accordingly, the vehicle security operation center may identify in which country the vehicle that has transmitted the log is located through the session. In addition, the vehicle security operation center may identify an electronic control unit to which the collected log are related in the vehicle. The vehicle security operation center may sort the collected logs according to electronic control units in the vehicle. For example, the vehicle security operation center may sort the collected logs into to a multimedia electronic control unit, a transmission electronic control unit, a safety-related electronic control unit, etc.

In an operation S206, the vehicle security operation center may determine whether the frequency of the logs sorted by each of the one or log types satisfies a threshold value. For example, the vehicle security operation center may determine whether the frequency of the logs sorted by each of the one or more log types is equal to or greater than a threshold value. The vehicle security operation center may determine whether the frequency of the logs sorted by each of the one or more log types is equal to or greater than the threshold value. Here, the frequency of the log may be the number of times the log is generated for a set time. Additionally, or alternatively, the frequency of the log may be the amount (or size) of the log generated for the set time. For example, when the size of the log generated for the set time is greater than a predetermined value (e.g., 10 M), it may be determined that the frequency of the log is high. The vehicle security operation center may identify the frequency of the logs sorted by each of the one or more log types and may determine whether the frequency of the log is equal to or greater than the threshold value. According to one embodiment, the threshold value may vary depending on the type of the sorted log. For example, when the frequency of generation is higher based on the country in which the vehicle is located rather than the type of the vehicle, a threshold value based on the country in which the vehicle is located may be lower than a threshold value based on the type of the vehicle. In addition, the threshold value may vary depending on the type of the vehicle, the country in which the vehicle is located, i.e., the country in which the log is collected, and the electronic control unit. For example, the threshold value based on the type of the vehicle and/or the threshold value based on the electronic control unit may vary depending on the country in which the vehicle is located.

In one embodiment, the vehicle security operation center may re-collect a log from the vehicle when the frequency of the logs sorted by each type is less than the threshold value.

In an operation S208, the vehicle security operation center may perform specific analysis on a log for which the frequency is determined to be greater than or equal to the threshold value. The vehicle security operation center may perform specific analysis on the log for which the frequency is determined to be greater than or equal to the threshold value, rather than all the logs sorted by each type. When it is determined that the frequency of the log sorted by the log type satisfies the threshold value (e.g., is equal to or greater than the threshold value), the vehicle security operation center may perform specific analysis on the log determined that the frequency is greater than or equal to the threshold value. The specific analysis of the vehicle security operation center may analyze whether the identified log is related to the IDS of the vehicle. Alternatively, the specific analysis of the vehicle security operation center may analyze whether the identified log is related to the electronic control unit of the vehicle.

In an operation S210, the vehicle security operation center may respond to control at least one vehicle, among the one or more vehicles, to perform one or more operations based on the result of the specific analysis. For example, as the result of the specific analysis, when the log identified that the frequency is greater than or equal to the threshold value is related to the IDS of the vehicle, the vehicle security operation center may update an IDS ruleset of the vehicle. The vehicle security operation center may transmit the IDS ruleset to the vehicle immediately or transmit the IDS ruleset at a scheduled time. Here, the scheduled time may be when the vehicle is turned on or off. As another example, as the result of the specific analysis, when it is analyzed that the logs identified that the frequency is greater than or equal to the threshold value are related to the electronic control unit included in the vehicle, the vehicle security operation center may respond in relation to the electronic control unit. For example, when it is analyzed that the identified logs are related to a multimedia electronic control unit, the vehicle security operation center may request the vehicle to turn off the multimedia electronic control unit or request the vehicle to update the related software.

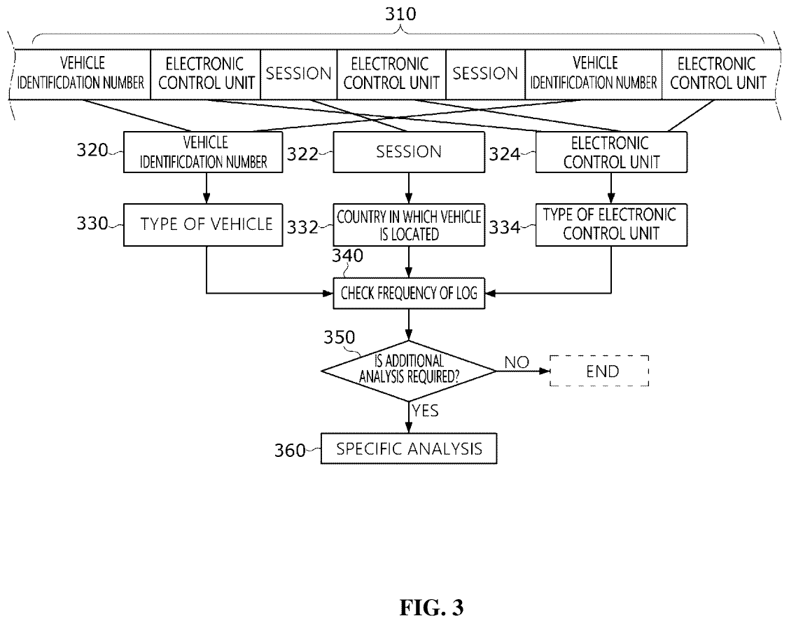

FIG. 3 is a flowchart illustrating operations of the vehicle security operation center that sorts logs collected from the vehicle and determines whether specific analysis is required, according to an embodiment of the present disclosure.

Referring to FIG. 3, the vehicle security operation center may receive a log 310 of the vehicle from the vehicle through a communication module. The log 310 of the vehicle may include information on at least some of a VIN, a session, and an electronic control unit. The vehicle security operation center may sort the log 310 of the vehicle using the information included in the received log 310 of the vehicle.

The vehicle security operation center may identify a type 330 of the vehicle from a VIN 320 among the information included in the log 310 of the vehicle. The VIN 320 may include information on an international designation identifier and the type of the vehicle. The vehicle security operation center may identify a country 332 in which the vehicle is located from a session 322 among the information included in the log 310 of the vehicle and identify a type 334 of the electronic control unit related to the log generated from an electronic control unit 324. Although it has been described that the vehicle security operation center may identify the type 330 of the vehicle, the country 332 in which the vehicle is located, and the type 334 of electronic control unit related to the log from the VIN 320, the session 322, and the electronic control unit 324 that are included in the log 310 of the vehicle, the vehicle security operation center may identify the type 330 of the vehicle, the country 332 in which the vehicle is located, and the type 334 of the electronic control unit related to the log using other information included in the log 310 of the vehicle. In addition, the vehicle security operation center may identify other information from the VIN 320, the session 322, and the electronic control unit 324 that are included in the log 310 of the vehicle and determine whether specific analysis is required.

The vehicle security operation center may identify the frequency of the type 330 of the vehicle, the country 332 in which the vehicle is located, and the type 334 of the electronic control unit related to the log from the received log 310 of the vehicle. For example, the vehicle security operation center may identify the frequency of the log including each of the VIN 320, the session 322, and the electronic control unit 324 in the received log 310 of the vehicle in an operation 340.

The vehicle security operation center may determine whether additional analysis is required for the sorted log 310 of the vehicle in an operation 350. The vehicle security operation center may compare the identified frequency of the log with a threshold value and determine whether additional analysis is required. For example, the vehicle security operation center may determine that additional analysis is required when the identified frequency of the log exceeds the threshold value. In one embodiment, the threshold value may vary depending on the type 330 of the vehicle, the country 332 in which the vehicle is located, and the type 334 of the electronic control unit related to the log. As another example, the vehicle security operation center may determine that additional analysis is required when the identified frequencies of logs exceed the threshold value.

When it is determined that additional analysis is required, the vehicle security operation center may perform specific analysis in an operation 360. In an embodiment, when it is determined that additional analysis is not required, the vehicle security operation center may finish or re-perform the aforementioned process from the beginning.

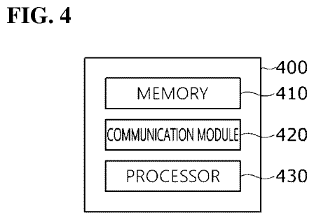

FIG. 4 is a block diagram of the vehicle security operation center according to one embodiment of the present disclosure.

Referring to FIG. 4, a vehicle security operation center 400 may include a memory 410, a communication module 420, and a processor 430.

The memory 410 may store various programs and data required for operating the vehicle security operation center 400. For example, the memory 410 may store commands for driving the processor 430. In addition, the memory 410 may store a threshold value for the processor 430 to determine whether specific analysis is required and store countermeasures for controlling the IDS ruleset and/or the electronic control unit of the vehicle. In addition, the memory 410 may store a log collected from the vehicle.

The communication module 420 may allow the vehicle security operation center 400 to transmit and receive data with other devices. Specifically, the communication module 420 may receive the log from the vehicle and transmit data for controlling the IDS ruleset or the electronic control unit included in the vehicle to the vehicle.

The processor 430 may collect logs from the vehicle through the communication module 420. The processor 430 may monitor the collected logs. The processor 430 may sort the collected logs by each log type. The processor 430 may sort the logs by each log type to efficiently analyze a large amount of logs. In this case, the processor 430 may subdivide the sorting criteria and automatically sort the logs. The sorting criteria may be at least some of the type of the vehicle, the country in which the vehicle is located, and the electronic control unit included in the vehicle. The processor 430 may identify the type of the vehicle using the VIN. Since first three digits of the VIN may indicate the international designation identifier, and a fourth digit may indicate information on the type of the vehicle, the processor 430 may identify the VIN in order to identify the type of the vehicle. The processor 430 may identify the country in which the vehicle is located through the session. In addition, the processor 430 may identify an electronic control unit to which the collected log is related in the vehicle.

The processor 430 may identify the frequency of the logs sorted by each log type and may determine whether the frequency satisfies a threshold value. For example, the processor 430 may compare the frequency with a threshold value. Here, the frequency of the logs may be determined by the number of times the log is generated in a set period of time and/or the size (or size) of the log generated in the set period of time. When the size of the log generated in the set period of time is large, the frequency of the log may be high, and thus the frequency of the log may be identified using the size of the generated log. The processor 430 may identify the frequency of the logs sorted by a log type and determine whether the frequency satisfies the threshold value (e.g., is equal to or greater than the threshold value). The threshold value may be determined based on one or more of the log types. For example, in the case of the threshold value, the threshold value based on the type of the vehicle and/or the threshold value based on the electronic control unit may vary depending on the country in which the vehicle is located. According to an embodiment, the threshold values may all be the same regardless of the type of the log type.

The processor 430 may re-collect a log from the vehicle when the frequency of the logs sorted by each log type is less than the threshold value.

The processor 430 may perform specific analysis on the log determined that the frequency is greater than or equal to the threshold value. The processor 430 may perform specific analysis on the log determined that the frequency of the logs sorted by the log type is greater than or equal to the threshold value. For example, the processor 430 may analyze whether the identified log is related to the IDS of the vehicle. The processor 430 may analyze whether the identified log is related to the electronic control unit included in the vehicle.

The processor 430 may respond based on the result of the specific analysis. The processor 430 may respond to control at least one vehicle, among the one or more vehicles, to perform one or more operations based on the result of the specific analysis. For example, as the result of the specific analysis, when the log identified that the frequency is greater than or equal to the threshold value is related to the IDS of the vehicle, the vehicle security operation center may update the IDS ruleset of the vehicle. Alternatively, as the result of the specific analysis, when it is analyzed that the logs identified that the frequency is greater than or equal to the threshold value are related to the electronic control unit included in the vehicle, the vehicle security operation center may respond in relation to the corresponding electronic control unit. The responses related to the electronic control unit may be pre-determined. The responses are pre-determined and stored for each electronic control unit, and the processor 430 may respond based on this.

According to embodiments of the present disclosure, it is possible to collect a log from a vehicle at a vehicle security operation center and detect and analyze an abnormality that occurs in the vehicle.

In addition, according to the embodiments of the present disclosure, it is possible to sort logs, which require specific analysis, among logs collected from the vehicle and perform the specific analysis.

In addition, according to the embodiments of the present disclosure, it is possible to analyze the log collected from the vehicle and respond based on the result of the analysis.

Although embodiments have been mainly described above, these are only illustrative and do not limit the present disclosure. Those of ordinary skill in the art to which the present disclosure pertains should appreciate that various modifications and applications not illustrated above are possible without departing from the essential characteristics of the embodiments. For example, each component specifically shown in the embodiments may be implemented by modification. In addition, differences related to these modifications and applications should be construed as being included in the scope of the present disclosure defined in the appended claims.

What is claimed is:

1. A method of detecting and analyzing an abnormality in a vehicle by a vehicle security operation center, the method comprising:
collecting logs from a vehicle;
sorting the collected logs by each type;
determining whether a frequency of the logs sorted by each type is a threshold value or more;
performing a specific analysis on logs determined that a frequency is greater than or equal to the threshold value; and
responding to control the vehicle to perform one or more operations based on a result of the specific analysis.

2. The method of claim 1, wherein the types for sorting the collected logs are include at least some of a type of the vehicle, a country in which the vehicle is located, and an electronic control unit included in the vehicle.

3. The method of claim 1, wherein performing the specific analysis includes determining whether the logs determined to have the frequency that is equal to or greater than the threshold value are related to an intrusion detection system (IDS) of a vehicle or are related to an electronic control unit included in the vehicle.

4. The method of claim 3, wherein responding includes, based on determining, as the result of the specific analysis, that the logs determined to have the frequency equal to or greater than the threshold value are related to the IDS of the vehicle, updating an IDS ruleset of the vehicle.

5. The method of claim 3, wherein responding includes, based on determining, as the result of the specific analysis, that the logs determined to have the frequency equal or greater than the threshold value are related to the electronic control unit included in the vehicle, the responding includes responding in relation to the electronic control unit included in the vehicle.

6. The method of claim 1, further comprising re-collecting logs from the vehicle based on determining that none of the frequencies are equal to or greater than the threshold value.

7. The method of claim 1, wherein the threshold value is determined based on one or more of the types of the logs.

8. The method of claim 1, wherein the frequency of the logs is determined according to one or both of a number of times the logs are generated in a set period of time or a size of the logs.

9. A vehicle security operation center for detecting and analyzing vehicle abnormality, the security vehicle operation center comprising:
a memory;
a communication module; and
a processor configured to
collect logs from one or more vehicles,
sort the collected logs by each type, identify whether a frequency of the logs a threshold value or more,
perform a specific analysis on the logs identified that the frequency is greater than or equal to the threshold value, and
respond to control at least one vehicle, among the one or more vehicles, to perform one or more operations based on a result of the specific analysis.

10. The vehicle security operation center of claim 9, wherein the types of logs are at least some of a type of a vehicle, a country in which the vehicle is located, or an electronic control unit included in the vehicle.

11. The vehicle security operation center of claim 9, wherein the processor is configured to perform the specific analysis to determine whether the logs determined to have the frequency equal to or greater than the threshold value are related to an intrusion detection system (IDS) of a vehicle or related to an electronic control unit included in the vehicle.

12. The vehicle security operation center of claim 11, wherein the processor is configured to update an IDS ruleset of the vehicle based on determining, as the result of the specific analysis, that the logs determined to have the frequency equal to or greater than the threshold value are related to the IDS of the vehicle.

13. The vehicle security operation center of claim 11, wherein the processor is configured to respond in relation to the electronic control unit based on determining, as the result of the specific analysis, that the logs determined to have the frequency equal to or greater than the threshold value are related to the electronic control unit included in the vehicle.

14. The vehicle security operation center of claim 9, wherein the processor is further configured to re-collect logs from the vehicle based on determining that none of the frequencies are equal to or greater than the threshold value.

15. The vehicle security operation center of claim 9, wherein the threshold value is determined based on one or more of the types of the logs.

16. The vehicle security operation center of claim 9, wherein the frequency is determined according to one or both of a number of times the logs are generated in a set period of time or a size of the logs.
